(19) United States
(12) Patent Application Publication
(10) Pub. No.: US 2005/0132834 A1
(43) Pub. Date: Jun. 23, 2005

(54) Resin gear

(75) Inventor: Yoichi Takeuchi, Kawaguchi-shi (JP)

Correspondence Address: BACHMAN & LAPOINTE, P.C., 900 CHAPEL STREET, SUITE 1201, NEW HAVEN, CT, 06510, US

(73) Assignee: Enplas Corporation

(21) Appl. No.: 11/016,452

(22) Filed: Dec. 17, 2004

(30) Foreign Application Priority Data
Dec. 19, 2003 (JP) 2003-422581

(51) Int. Cl. F16H 55/18

(52) U.S. Cl. 74/431; 74/DIG. 10

(57) ABSTRACT

A resin gear is formed by connecting a rim having teeth on the outer periphery thereof to a hub by means of a substantially annular web having a thin portion which is thinner than the rim and which is curved in facewidth directions, the thin portion being elastically deformable so as to allow a relative displacement in radial directions between the rim and the hub while preventing a relative displacement in rotational directions between the rim and the hub.

### BACKGROUND OF THE INVENTION

1. Field of the Invention

The present invention generally relates to a resin gear constituting a power transmission device. More specifically, the invention relates to a resin gear capable of eliminating backlash so as to smoothly and precisely transmit rotation without backlash.

2. Description of the Prior Art

In general, gears are designed to provide backlash so as to be capable of smoothly rotating while meshing with a companion gear, in view of manufacturing tolerance, deformation of teeth, meshing deviation due to deflection of shaft, and so forth. However, since backlash is provided by a clearance between teeth of a pair of gears meshing with each other, if rotation and stop are frequently repeated or if normal rotation and reverse rotation are repeated, teeth meshing with each other collide with each other to produce noises. In sensors or the like for measuring rotation transmitted by gears, errors of rotation due to backlash are directly measurement errors, so that backlash is preferably as small as possible.

Therefore, in each of gears disclosed in Japanese Patent Laid-Open Nos. 2000-220669, 8-233071 and 63-19470, a rim having teeth and a hub having an axial hole are connected to each other by means of a plurality of flexibly deformable ribs which are designed to be flexibly deformed to press the gear against a meshing companion gear to cause the pair of gears meshing with each other to tightly contact each other to remove backlash caused between the gears.

According to such gears, the contact pressure between the tooth flanks of teeth of the gear and meshing companion gear is caused by the elastic force of the ribs, so that the elastic deformation of the ribs can displace the teeth in such a direction that the gear is disengaged from the companion gear. Therefore, it is expected to allow smooth transmission of rotation without causing defective rotation due to elimination of backlash.

However, in such conventional gears, since the ribs connecting the rim to the hub can be elastically deformed so as to allow the relative rotational displacement between the rim and the hub, the ribs are flexibly deformed by rotational torque during power transmission, so that the rim and the hub are displaced in rotational directions by the elastic deformation of the rim. If such displacement in rotational directions is caused, measurement errors of rotational displacement are caused when the rotational displacement of a shaft, which is fitted into the axial hole of the hub so as to be rotatable therewith, is measured by a sensor, for example.

### SUMMARY OF THE INVENTION

It is therefore an object of the present invention to eliminate the aforementioned problems and to provide a resin gear capable of eliminating backlash and more precisely transmitting rotation than conventional gears.

In order to accomplish the aforementioned and other objects, according one aspect of the present invention, a resin gear comprises: a rim having teeth on an outer periphery thereof; a shaft supporting portion for receiving and supporting therein a shaft; and a substantially disk-shaped web connecting an inner surface of the rim to an outer surface of the shaft supporting portion, the web having a thin portion which is thinner than the rim and which is curved in facewidth directions, the thin portion being elastically deformable so as to allow a relative displacement in radial directions between the rim and the shaft supporting portion.

In this resin gear, the web may be connected to a substantially central portion of the inner surface of the rim in face width directions and to a substantially central portion of the outer surface of the shaft supporting portion in facewidth directions. The thin portion may be elastically deformable so as to prevent a relative displacement in rotational directions between the rim and the shaft supporting portion. The thin portion may extend in circumferential directions while being corrugated in facewidth directions. The thin portion may have a substantially constant thickness. The thin portion may be made of a material different from that of the rim and the shaft supporting portion. The rim, the shaft supporting portion and the web may be formed so as to be integrated with each other.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a longitudinal section of a preferred embodiment of a resin gear according to the present invention, which is taken along line I-I of FIG. 2;

FIG. 2 is a front view of the resin gear in the preferred embodiment;

FIG. 3 is a schematic enlarged view of a tooth of the resin gear in the preferred embodiment when the gear meshes with a companion gear;

FIG. 4 is a sectional view of a first modified example of a resin gear according to the present invention, which corresponds to FIG. 1;

FIG. 5 is a sectional view of a second modified example of a resin gear according to the present invention, which corresponds to FIG. 1; and

FIG. 6 is a sectional view of a third modified example of a resin gear according to the present invention, which corresponds to FIG. 1.

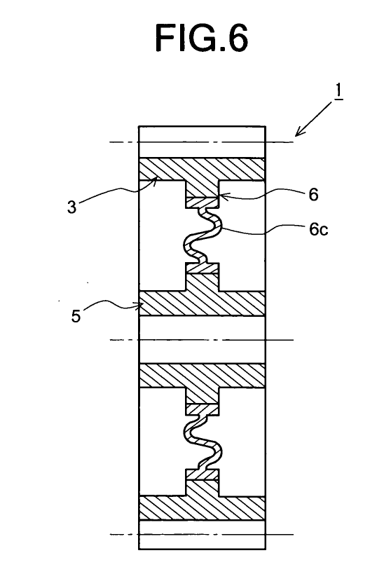

### DESCRIPTION OF THE PREFERRED EMBODIMENTS

Referring now to the accompanying drawings, the preferred embodiment of a resin gear according to the present invention will be described below in detail.

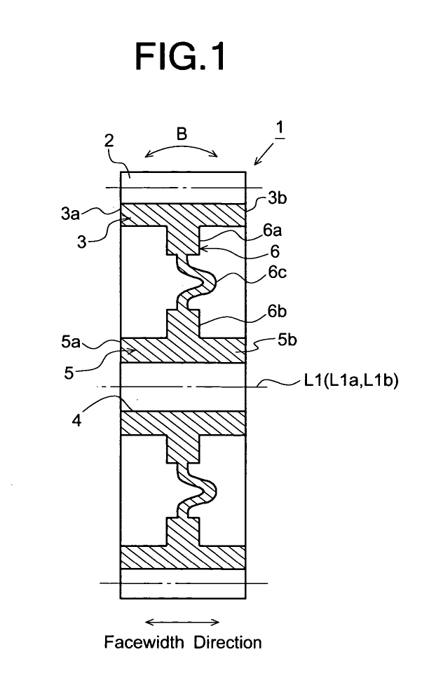

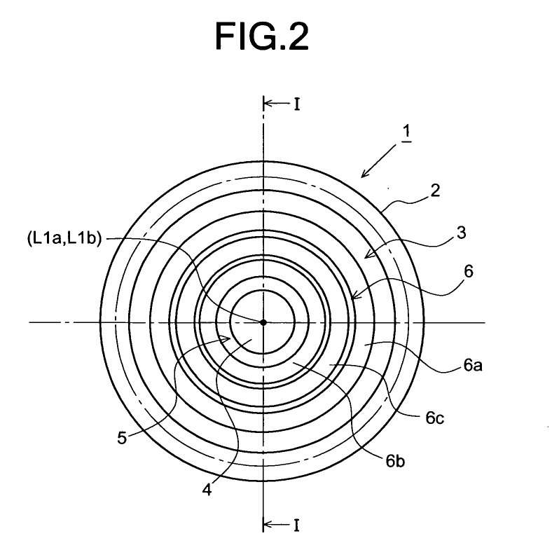

FIGS. 1 and 2 show the preferred embodiment of a resin gear 1 according to the present invention. FIG. 1 is a longitudinal section of the resin gear 1 taken along line I-I of FIG. 2, and FIG. 2 is a front view of the resin gear 1.

In these figures, the resin gear 1 is formed of, e.g., polyacetal, polyamide, polyphenylene sulfide or polybutylene terephthalate, by injection molding. The resin gear 1 comprises a rim 3 having teeth 2 on its outer periphery, a substantially cylindrical hub (a shaft supporting portion) 5 having an axial hole 4 at its center, and a web 6 connecting the rim 3 to the hub 5 in radial directions. In this preferred embodiment, the length of the hub 5 in directions of its axis (L1) is the same as the facewidth of the gear, and both ends 5a and 5b of the hub 5 in axial directions are substantially arranged on the same plates as those of both ends 3a and 3b of the rim 3 in facewidth directions, respectively.

The web 6 has a connecting portion 6a to the rim 3, and a connecting portion 6b to the hub 5. The connecting portions 6a and 6b substantially have the same thickness as that of the rim 3 and hub 5, and have a substantially annular shape. The connecting portions 6a and 6b of the web 6 are connected to each other by means of an elastically deformable portion 6c which is thinner than the connecting portions 6a and 6b. That is, a part of the web 6 in radial directions is the thin elastically deformable portion 6c. Furthermore, the connecting portions 6a and 6b are connected to the substantially central portion of the rim 3 in facewidth directions, and to the substantially central portion of the hub 5 in axial directions, respectively.

The elastically deformable portion 6c of the web 6 is curved in a facewidth direction (to the right in FIG. 1), and is designed to be flexibly deformed so as to allow the relative displacement of the rib 3 and hub 5 in radial directions. The outside end of the elastically deformable portion 6c in radial directions is connected to the substantially central portion of the outside connecting portion 6a in facewidth directions, and the inside end of the elastically deformable portion 6c in radial directions is connected to the substantially central portion of the inside connecting portion 6b in facewidth directions. Thus, if the elastically deformable portion 6c is elastically deformed, the elastic force of the elastically deformable portion 6c presses the substantially central portion of the rim 3 in facewidth directions, so that torque or angular moment in directions of arrow B in FIG. 1 does not act on the rim 3. As a result, the teeth 2 of the rim 3 can contact the teeth of a meshing companion gear (not shown) at uniform contact pressures in facewidth directions, so that it is possible to prevent biased wear from being caused by unbalanced contact pressures.

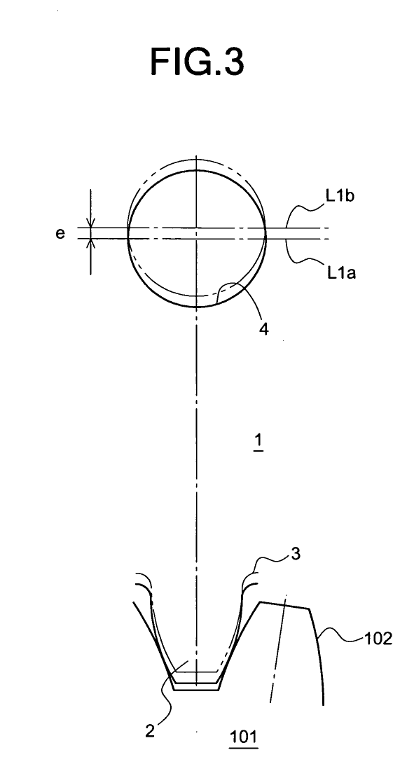

FIG. 3 is a schematic enlarged view of the resin gear 1 in this preferred embodiment when the gear 1 meshes with a companion gear 101. As shown in FIG. 3, the resin gear 1 in this preferred embodiment is mounted so that the center L1a of the axial hole 4 (the rotation center of the hub 5) is eccentrically arranged with respect to the rotation center L1b of the rim 3 toward the companion gear 101. In view of variation in precision of tooth profile, variation in dimension between the shafts of the meshing gears 1 and 101 and so forth, the eccentric amount (the displacement between the rotation centers) e is so set as to be capable of eliminating backlash and causing the tooth flanks of the meshing teeth 2 and 102 to tightly contact each other without clearance (see FIG. 3).

Thus, in the resin gear 1 in this preferred embodiment, a part of the elastically deformable portion 6c arranged between the hub 5 and the companion gear 101 is compressed to be elastically deformed to press the rim 3 against the companion gear 101 by the elastic force thereof. Thus, the meshing state of the resin gear 1 in this preferred embodiment with the companion gear 101 is maintained (see FIG. 3).

Furthermore, the optimum thickness of the elastically deformable portion 6c is determined in accordance with various conditions, such as module, outside dimension and contact pressure between the meshing teeth 2 and 102.

In the resin gear 1 in this preferred embodiment with this construction, the part of the web 6 is the thin elastically deformable portion 6c which is curved in face width directions, so that the elastic deformation of the elastically deformable portion 6c allows the relative displacement of the hub 5 and rim 3 in radial directions. However, the elastically deformable portion 6c has a substantially (annular) disk shape to have very high rigidity in rotational directions, so that it is possible to prevent the relative displacement in rotational directions between the hub 5 and the rim 3.

Thus, according to the resin gear 1 in this preferred embodiment, it is possible to transmit rotation while eliminating backlash, and it is possible to prevent the relative displacement in rotational directions between the rim 3 and the hub 5, so that it is possible to smoothly and precisely transmit rotation;

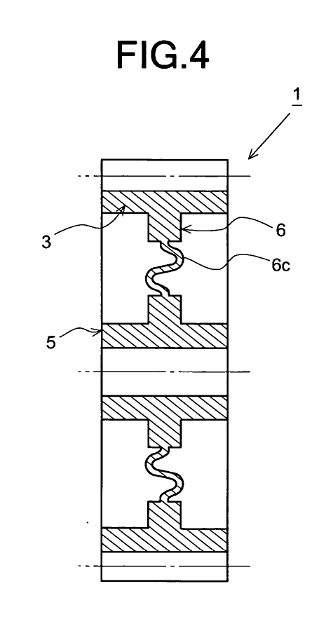

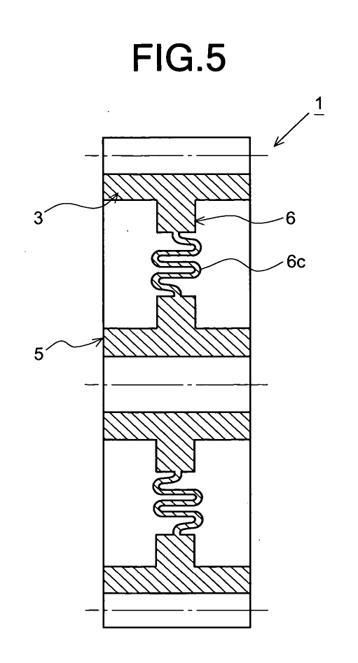

While the elastically deformable portion 6c has been formed so as to have only one curved deformable portion in the above described preferred embodiment, the present invention should not be limited thereto, but the elastically deformable portion 6c may have a plurality of curved deformable portions in radial directions. For example, two curved deformable portions may be sequentially formed in radial directions as shown in FIG. 4, or four curved deformable portions maybe sequentially formed in radial directions as shown in FIG. 5. Alternatively, the elastically deformable portion 6c may be formed of an easily deformable material (a material having a large elastic modulus) which is different from the material of the rim 3 and hub 5.

While the part of the web 6 has been the elastically deformable portion 6c in the above described preferred embodiment, the whole web 6 may be elastically deformable. Such a construction can be effectively applied to a resin gear having a small diameter.

While the axial hole 4 has been formed in the hub 5 in the above described preferred embodiment, the present invention should not be limited thereto, but the hub 5 may be integrally formed with a supporting shaft (not shown).

The resin gear according to the present invention may be widely used for power transmission devices required to smoothly and precisely transmit rotation. In particular, if the resin gear according to the present invention is used for a rotational displacement measuring portion of precise measuring apparatuses and instruments, it is possible to improve the precision of measurement.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A resin gear comprising:
a rim having teeth on an outer periphery thereof;
a shaft supporting portion for receiving and supporting therein a shaft; and
a substantially disk-shaped web connecting an inner surface of said rim to an outer surface of said shaft supporting portion, said web having a thin portion which is thinner than said rim and which is curved in facewidth directions, said thin portion being elastically deformable so as to allow a relative displacement in radial directions between said rim and said shaft supporting portion.

2. A resin gear as set forth in claim 1, wherein said web is connected to a substantially central portion of said inner surface of said rim in facewidth directions and to a substantially central portion of said outer surface of said shaft supporting portion in facewidth directions.

3. A resin gear as set forth in claim 1, wherein said thin portion is elastically deformable so as to prevent a relative displacement in rotational directions between said rim and said shaft supporting portion.

4. A resin gear as set forth in claim 1, wherein said thin portion extends in circumferential directions while being corrugated in facewidth directions.

5. A resin gear as set forth in claim 1, wherein said thin portion has a substantially constant thickness.

6. A resin gear as set forth in claim 1, wherein said thin portion is made of a material different from that of said rim and said shaft supporting portion.

7. A resin gear as set forth in claim 1, wherein said rim, said shaft supporting portion and said web are formed so as to be integrated with each other.
